(19) United States
(12) Patent Application Publication
(10) Pub. No.: US 2016/0201886 A1
(43) Pub. Date: Jul. 14, 2016

(54) Magnetic Light

(71) Applicant: Scott Wang, Los Angeles, CA (US)

(72) Inventor: JingJie SHEN, Ningbo (CN)

(73) Assignee: Scott Wang

(21) Appl. No.: 14/754,429

(22) Filed: Jun. 29, 2015

Related U.S. Application Data
(60) Provisional application No. 62/101,273, filed on Jan. 8, 2015.

(51) Int. Cl. F21V 21/096; F21L 4/00

(52) U.S. Cl. CPC F21V 21/0965; F21L 4/005; F21W 2101/023

(57) ABSTRACT

A magnetic light includes a main casing and an illumination module. The illumination module includes an illuminating unit, a magnetic element and a processing circuitry. The illuminating unit is supported on the main casing and arranged to generate at least one predetermined illumination pattern. The magnetic element is mounted on the main casing for magnetically attracting to an external magnetic object. The processing circuitry is provided in the receiving compartment and is electrically connected to the illuminating unit and the magnetic element, in such a manner that when the magnetic element is magnetically attracted to the external magnetic object, the illuminating unit is activated to generate the illuminating pattern.

### BACKGROUND OF THE PRESENT INVENTION

1. Field of Invention

The present invention relates to an illuminating device, and more particularly to a magnetic light which is capable of generating a predetermined illumination pattern when it is magnetically attracted to an external magnetic object, such as a metallic object.

2. Description of Related Arts

A conventional lighting device for a bicycle, such as a conventional bike light, usually comprises a main body, an illumination device supported by the body, and a mounting arrangement provided on the main body for mounting the main body on a predetermined position of the bicycle.

A major disadvantage of the above-mentioned bike light is that a specific mounting mechanism must be used for mounting the bike light on the bicycle. Very often, a specific bracket must be mounted on the bicycle for accommodating bike light. The processes of attaching and detaching the bike light on the and from the bicycle are very time-consuming and troublesome. Unfortunately however, the bike light must be periodically detached from the bicycle for performing proper maintenance. After maintenance, the bike light has to be re-attached to the bicycle. Sometimes, the mounting process requires a certain amount of mechanical techniques and some people may be deterred from using certain types of bike lights.

As a result, there is a need for an illuminating device which can be conveniently and easily mounted on and detached from a bicycle.

### SUMMARY OF THE PRESENT INVENTION

An objective of the present invention is to provide a magnetic light which is capable of generating a predetermined illumination pattern when it is magnetically attracted to an external magnetic object, such as a metallic object.

Another objective of the present invention is to provide a magnetic light which can be easily mounted to an existing bicycle without needing any accessories, tools, or brackets. Thus, the magnetic light of the present invention is universal in the sense that it fits all existing bicycles which are having metallic frames.

Another objective of the present invention is to provide a magnetic light which is capable of generating a number of different illumination patterns. The illumination patterns are switched by detaching and re-attaching the magnetic light from and to the bicycle.

In one aspect of the present invention, it provides a magnetic light, comprising:

a main casing having a receiving compartment for receiving a power source; and

an illumination module, which comprises:

an illuminating unit which is supported on the main casing and is arranged to generate at least one predetermined illumination pattern;

a magnetic element mounted on the main casing for magnetically attracting to an external magnetic object; and

a processing circuitry provided in the receiving compartment and is electrically connected to the illuminating unit and the magnetic element, in such a manner that when the magnetic element is magnetically attracted to the external magnetic object, the illuminating unit is activated to generate the illuminating pattern.

### BRIEF DESCRIPTION OF THE DRAWINGS

FIG. 1 is a perspective view of a magnetic light according to a preferred embodiment of the present invention.

FIG. 2 is an exploded perspective view of the magnetic light according to the preferred embodiment of the present invention.

FIG. 3 is a sectional side view of the magnetic light according to the preferred embodiment of the present invention.

FIG. 4 is a perspective view of a coupling member of the magnetic light according to the preferred embodiment of the present invention.

FIG. 5 is another perspective view of a coupling member of the magnetic light according to the preferred embodiment of the present invention, illustrating that the coupling rims have a different diameter.

FIG. 6 is a block diagram of the magnetic light according to the preferred embodiment of the present invention.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

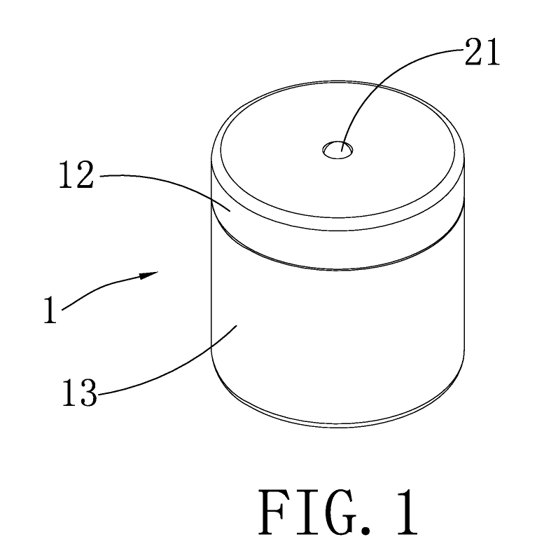

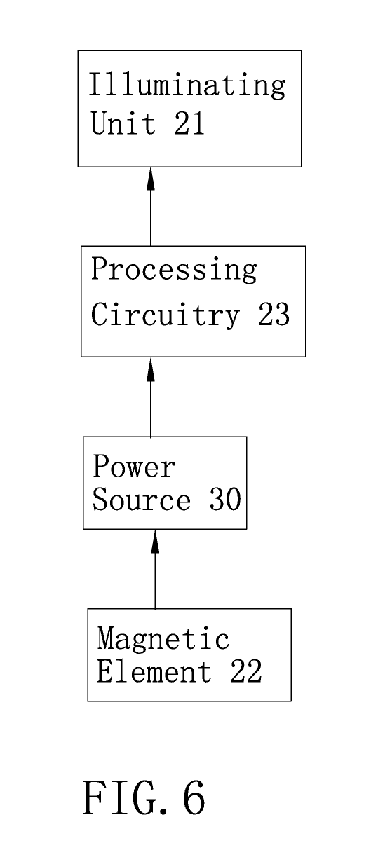

Referring to FIG. 1 to FIG. 6 of the drawings, a magnetic light according to a preferred embodiment of the present invention is illustrated. Broadly, the magnetic light comprises a main casing 1, and an illumination module 2.

The main casing 1 has a receiving compartment 11 for receiving a power source 30, such as a battery. The illumination module 2 comprises an illuminating unit 21, a magnetic element 22, and a processing circuitry 23.

The illuminating unit 21 is supported on the main casing 1 and is arranged to generate at least one predetermined illumination pattern towards a predetermined direction.

The magnetic element 22 is mounted on the main casing 1 for magnetically attracting to an external magnetic object, such as a metallic bicycle frame.

The processing circuitry 23 is provided in the receiving compartment 11 and is electrically connected to the illuminating unit 21 and the magnetic element 22, in such a manner that when the magnetic element 22 is magnetically attracted to the external magnetic object such as the metallic bicycle frame, the illuminating unit 21 is activated to generate the illuminating pattern.

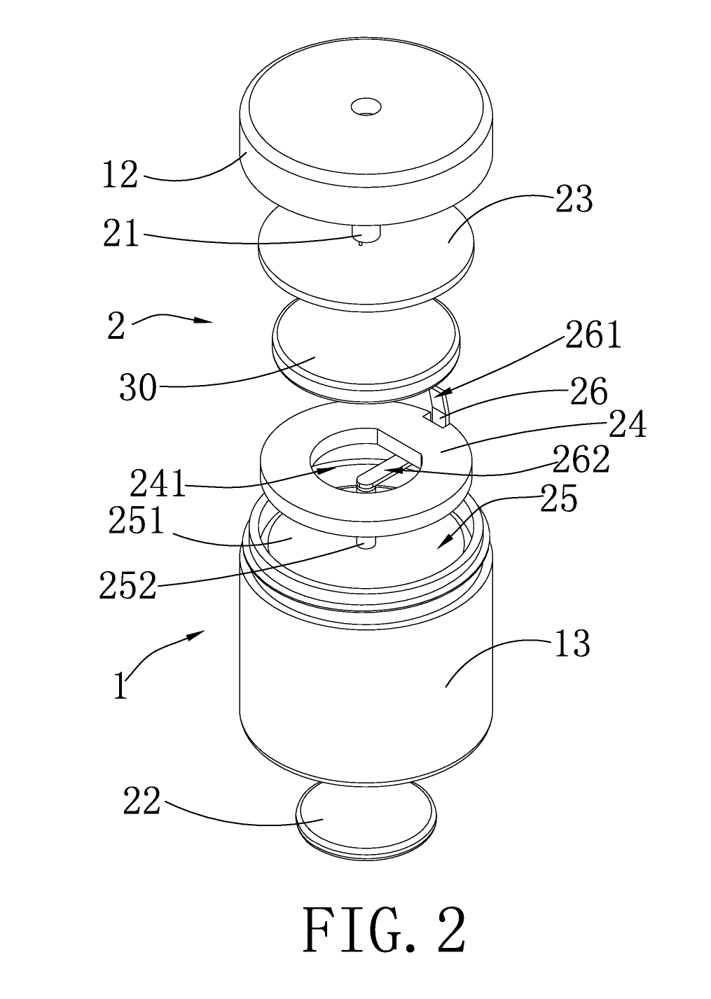

According to the preferred embodiment of the present invention, the main casing 1 may have a circular cross section and comprises a first casing member 12 and a second casing member 13 detachably connected to the first casing member 12. Each of the first casing member 12 and the second casing member 13 has a circular cross section and forms a hollow structure such that the receiving chamber 11 is defined within the first casing member 12 and the second casing member 13 when they are attached with each other. As shown in FIG. 1 to FIG. 2 of the drawings, the illuminating unit 21 is provided on the first casing member 12 while the magnetic element 22 is provided on the second casing member 13 at a position which is opposite to the illuminating unit 21. The second casing member 13 has a tubular structure.

The illuminating unit 21 of the illumination module 2 comprises a LED which is capable of generating illumination of a predetermined color. The processing circuitry 23 is implemented on a Printed Circuit Board and is electrically connected to the illuminating unit 21. When the processing circuitry 23 is electrically connected to the power source 30, the processing circuitry 23 is arranged to drive the illuminating unit 21 to generate a predetermined illumination pattern, such as blinking lights. The magnetic element 22 is preferably a magnet which can magnetically attached to metallic object.

The illumination module 2 further comprises a supporting member 24 received in the second casing member 13 for forming a supporting seat for the power source 30. The power source 30 such as a predetermined number of batteries is arranged to be placed in the second casing member 13 and supported by the supporting member 24. As shown in FIG. 2 of the drawings, the supporting member 24 has a circular cross section and has a central opening 241.

The illumination module 2 further comprises an electrical terminal 26 mounted in the receiving compartment 11 and supported by the supporting member 24 for conducting electricity between the power source 30 and the processing circuitry 30. The electrical terminal 26 is configured from metallic material and has an elongated structure which is bent to form a longitudinal portion 261 which is longitudinally extended along a longitudinal direction of the second casing member 13, and a transverse portion 262 transversely extended along a transverse direction of the second casing member 12 underneath the supporting member 24. Thus, the transverse portion 262 of the electrical terminal 26 is exposed to an electrical terminal of the power source 30 through the central opening 241 of the supporting member 24. Moreover, an insulating member 263 is provided on the longitudinal portion 261.

The illumination module 2 further comprises a coupling member 25 movably mounted in the second casing member 13 at a position underneath the supporting member 24. A spring 27 may be provided between the coupling member 25 and the supporting member 24 for exerting a normal downward force against the coupling member 25. The coupling member 25 comprises a main body 251 which is circular in cross sectional shape, a supporting stem 252 upwardly extended from a top surface of the main body 251 for biasing against the transverse portion 262 of the electrical terminal 26, and a plurality of coupling rims 253 downwardly extended from a bottom surface of the main body 251. Each of the coupling rims 253 has a semi-circular cross section having a predetermined radius. The coupling member 25 is mounted in the second casing member 13 in such a manner that it may slightly move along a longitudinal direction of the main casing 1.

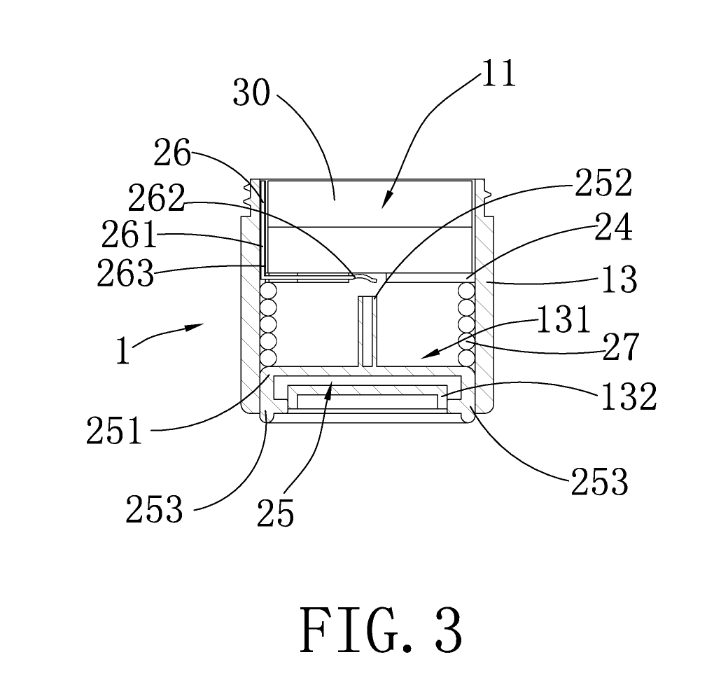

As shown in FIG. 3 of the drawings, the second casing member 13 further has an indention 131 formed at the end where the magnetic element 22 is mounted, and a mounting bracket 132 formed within the indention 131. The mounting bracket 132 has a radius which is substantially the same as that of the magnetic element 22 so that the magnetic element 22 can be fittedly and securely accommodated within the mounting bracket 132. The coupling rims 253 concentrically extended outside the mounting bracket 132 but within the indention 131. Moreover, a portion of the coupling rims 253 is arranged to be exposed out of the indention 131.

The operation of the present invention is as follows: the illuminating unit 21 is normally switched off. This is accomplished by disengaging the transverse portion 262 of the electrical terminal 26 from the power source 30. When the magnetic element 22 is magnetically attracted to an external metallic object, such as a bicycle frame, the main casing 1 will be attracted to attach on the metallic object. The coupling rims 253 will be biased by the external metallic object to move slightly inwardly towards the second casing member 13. When the coupling rims 253 is pushed to move inwardly, the main body 251 and the supporting stem 252 will also be pushed inwardly so that the supporting stem 252 will push the transverse portion 262 of the electrical terminal 26 to bias against the power source 30. This electrically conducts the power source 30 with the processing circuitry 23 so that the processing circuitry 23 is activated to light up the illuminating unit 21.

When the main casing 10 is detached from the external metallic object, the biasing force mentioned above ceases to exist and the supporting stem 252 is relieved from biasing against the transverse portion 262 of the electrical terminal 26. Due to its inherent elasticity, the transverse portion 262 disengages from the power source 30 and the power for lighting up the illuminating unit 21 is cut-off. The illuminating unit 21 is thereby turned off.

According to the preferred embodiment of the present invention, the processing circuitry 23 is configured such that three illumination patterns are setup in a chipset. The each of the three illumination patterns will be sequentially activated every time the illuminating unit 21 is turned on. For example, the processing circuitry 23 may be configured to generate fast flashing lights, slow flashing lights, and a steady beam of light. These three illumination patterns will be activated in turn when the illuminating unit 21 is activated. For example, the first activation of the illuminating unit 21 will generate a fast flashing light, a second activation (a first subsequent activation) of the illuminating unit 21 will generate a slow flashing light, while a third activation (a second subsequent activation) of the illuminating unit 21 will generate a steady beam of light. This cycle continues for subsequent activations.

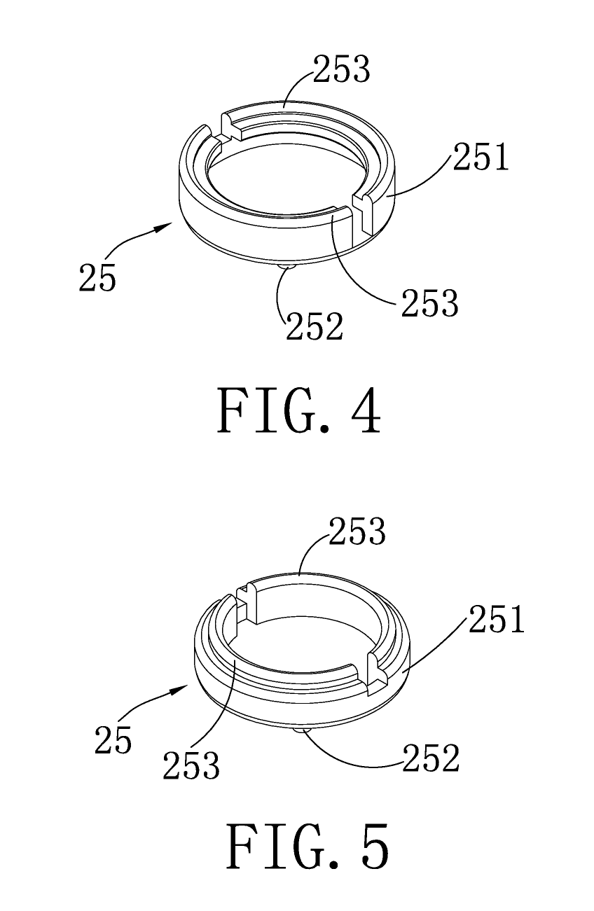

Referring to FIG. 4 and FIG. 5 of the drawings, two magnetic lights of the present invention may be used to form a magnetic light assembly. Each of the magnetic lights are structurally identical except the radius of the coupling rims 253. The coupling rims 253 of one of the magnetic light may have a smaller radius (FIG. 5) while the coupling rims 253 of another magnetic light may have a relatively larger radius (FIG. 4). As a result when the magnetic elements 22 attract to each other, the coupling rims 253 of one of the magnetic light is arranged to fittedly receive in the indention 131 of the other magnetic light. Thus, the polarity of the two magnetic elements 22 are opposite with each other.

The two magnetic lights may form a magnetic light assembly for ease of storage and carrying. Moreover, the two magnetic lights may be attached to two different positions of a bicycle for providing multiple lighting effects.

The present invention, while illustrated and described in terms of a preferred embodiment and several alternatives, is not limited to the particular description contained in this specification. Additional alternative or equivalent components could also be used to practice the present invention.

What is claimed is:

1. A magnetic light, comprising:
a main casing having a receiving compartment for receiving a power source; and
an illumination module, which comprises:
an illuminating unit which is supported on said main casing and is arranged to generate at least one predetermined illumination pattern;
a magnetic element mounted on said main casing for magnetically attracting to an external magnetic object; and
a processing circuitry provided in said receiving compartment and is electrically connected to said illuminating unit and said magnetic element, in such a manner that when said magnetic element is magnetically attracted to said external magnetic object, said illuminating unit is activated to generate said illuminating pattern.

2. The magnetic light, as recited in claim 1, wherein said main casing comprises a first casing member and a second casing member detachably connected to said first casing member.

3. The magnetic light, as recited in claim 2, wherein each of said first casing member and said second casing member has a circular cross section and forms a hollow structure such that said receiving chamber is defined within said first casing member and said second casing member when said first casing member and said second casing member are attached with each other.

4. The magnetic light, as recited in claim 3, wherein said illuminating unit is provided on said first casing member while said magnetic element is provided on said second casing member at a position which is opposite to said illuminating unit.

5. The magnetic light, as recited in claim 1, wherein when said processing circuitry is electrically connected to said power source, said processing circuitry is arranged to drive said illuminating unit to generate a predetermined illumination pattern.

6. The magnetic light, as recited in claim 4, wherein when said processing circuitry is electrically connected to said power source, said processing circuitry is arranged to drive said illuminating unit to generate a predetermined illumination pattern.

7. The magnetic light, as recited in claim 6, wherein said illumination module further comprises a supporting member received in said second casing member for forming a supporting seat for said power source, said supporting member having a central opening.

8. The magnetic light, as recited in claim 7, wherein said illumination module further comprises an electrical terminal mounted in said receiving compartment and supported by said supporting member for conducting electricity between said power source and said processing circuitry.

9. The magnetic light, as recited in claim 8, wherein said electrical terminal is configured from metallic material and has an elongated structure which is bent to form a longitudinal portion which is longitudinally extended along a longitudinal direction of said second casing member, and a transverse portion transversely extended along a transverse direction of said second casing member underneath said supporting member, such that said transverse portion is exposed to an electrical terminal of said power source through said central opening of said supporting member.

10. The magnetic light, as recited in claim 9, wherein said illumination module further comprises a coupling member movably mounted in said second casing member at a position underneath said supporting member.

11. The magnetic light, as recited in claim 10, wherein said coupling member comprises a main body, a supporting stem upwardly extended from said main body for biasing against said transverse portion of said electrical terminal, and a plurality of coupling rims downwardly extended from said main body, said coupling member being mounted in said second casing member in such a manner that said coupling member is slightly movable along a longitudinal direction of said main casing.

12. The magnetic light, as recited in claim 10, wherein said illumination module further comprises a spring provided between said coupling member and said supporting member for exerting a normal downward force against said coupling member.

13. The magnetic light, as recited in claim 11, wherein said illumination module further comprises a spring provided between said coupling member and said supporting member for exerting a normal downward force against said coupling member.

14. The magnetic light, as recited in claim 8, wherein said second casing member further has an indention formed at an end thereof where said magnetic element is mounted, and a mounting bracket formed within said indention, said mounting bracket having a radius substantially the same as that of said magnetic element for being fittedly and securely accommodated within said mounting bracket.

15. The magnetic light, as recited in claim 13, wherein said second casing member further has an indention formed at an end thereof where said magnetic element is mounted, and a mounting bracket formed within said indention, said mounting bracket having a radius substantially the same as that of said magnetic element for being fittedly and securely accommodated within said mounting bracket.

16. The magnetic light, as recited in claim 1, wherein said illuminating unit of said illumination module comprises a LED.

17. The magnetic light, as recited in claim 15, wherein said illuminating unit of said illumination module comprises a LED.

18. The magnetic light, as recited in claim 1, wherein said magnetic element is configured as a magnet.

19. The magnetic light, as recited in claim 8, wherein said magnetic element is configured as a magnet.

20. The magnetic light, as recited in claim 15, wherein said magnetic element is configured as a magnet.
